(19) United States
(12) Patent Application Publication
(10) Pub. No.: US 2019/0285182 A1
(43) Pub. Date: Sep. 19, 2019

(54) SEAL RING, SEALING ARRANGEMENT, AND USE OF A SEALING ARRANGEMENT

(71) Applicant: Carl Freudenberg KG, Weinheim (DE)

(72) Inventors: Sascha Moeller, Gilserberg (DE); Roland Fietz, Neustadt-Momberg (DE); Michael Groesch, Alsfeld (DE); Juergen Jaeckel, Schrecksbach (DE); Gonzalo Barillas, Alsfeld-Altenburg (DE)

(21) Appl. No.: 16/247,610

(22) Filed: Jan. 15, 2019

(30) Foreign Application Priority Data
Mar. 19, 2018 (EP) 18 162 472.7

(51) Int. Cl. F16J 15/3276; F16J 15/3284; F16J 15/3204; F04D 29/12

(52) U.S. Cl. CPC F16J 15/3276; F04D 29/122; F16J 15/3204; F16J 15/3284

(57) ABSTRACT

A seal ring in the form of a grooved ring for sealing a movable machine element toward a stationary housing includes: a radially inner axial leg with a dynamic sealing edge; a radially outer axial leg with a static sealing edge; and a radial leg connecting the two axial legs. The seal ring is produced from a thermoplastic material. A recess is formed between the two axial legs and the radial leg. The radially inner axial leg has, on a surface of the radially inner axial leg on a machine element side, a rounded transition to a surface of the radial leg that faces away from a pressure.

### CROSS-REFERENCE TO PRIOR APPLICATION

Priority is claimed to European Patent Application No. EP 18 162 472.7, filed on Mar. 19, 2018, the entire disclosure of which is hereby incorporated by reference herein.

### FIELD

The invention relates to a seal ring in the form of a grooved ring, to a sealing arrangement having such a seal ring, and to the use of a sealing arrangement.

### BACKGROUND

Special seals are used for sealing in high-pressure pumps. The use of grooved rings with flanges and with clamping rings as springs is customary, for example as described in WO 2010/075576 A3. Depicted there is a grooved ring made from a fluoropolymer, with a flange and two clamping rings as springs, for use in a high-pressure pump.

In designing the seal ring, a compromise is to be found between chemical resistance, good elasticity, and good extrusion resistance. Chemical resistance is given in most seals according to the prior art. However, problems are apparent with regard to elasticity and extrusion resistance. Due to the typically low elasticity, the use of springs is required, for example clamping rings. Due to the most often poor extrusion resistance, there is the risk that the material of the seal ring is extruded beyond the sealing gap, into the gap between the stationary housing and moving machine element.

### SUMMARY

In an embodiment, the present invention provides a seal ring in the form of a grooved ring for sealing a movable machine element toward a stationary housing, comprising: a radially inner axial leg with a dynamic sealing edge; a radially outer axial leg with a static sealing edge; and a radial leg connecting the two axial legs, wherein the seal ring is comprised of a thermoplastic material, wherein a recess is formed between the two axial legs and the radial leg, and wherein the radially inner axial leg has, on a surface of the radially inner axial leg on a machine element side, a rounded transition to a surface of the radial leg that faces away from a pressure.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 a first embodiment variant of a seal ring according to the invention

FIG. 2 a second embodiment variant of a seal ring according to the invention

FIG. 3 a third embodiment variant of a seal ring according to the invention

FIGS. 4a, b depictions of the design of the rounded transition of a seal ring according to the invention.

### DETAILED DESCRIPTION

The object of the present invention is therefore to provide a seal ring which simultaneously has good chemical resistance, good elasticity, and good extrusion resistance. The seal ring should also have a long service life. A further object is to describe a sealing arrangement with such a seal ring and the use of such a sealing arrangement.

This object is achieved by a seal ring as described herein. The seal ring according to the invention, in the form of a grooved ring, serves to seal a machine element toward a stationary housing, which machine element is movable in an axial direction. The seal ring is produced, in particular in one piece, from a thermoplastic material with high elasticity. High elasticity is understood to mean a high resilience. The seal ring has a radially inner axial leg with a dynamic sealing edge, a radially outer axial leg with a static sealing edge, and a radial leg connecting the two axial legs, wherein a groove-shaped depression, which can more generally be referred to as a cavity, is formed between the two axial legs and the radial leg. According to the invention, the radially inner axial leg has on its machine element-side surface a rounded, in particular soft and continuous transition to the surface of the radial leg facing away from the pressure. This shaping of the seal ring according to the invention and the choice of material for the seal ring ensure that the seal ring has good chemical resistance, a good return behavior, a high elasticity, and a high extrusion resistance. Because of its good elasticity, clamping rings or springs are no longer necessary. Or, in other words: Large strains do not lead to a high plastic (permanent) deformation but rather just to an elastic deformation, so that even without [a] spring element the sealing edges maintain contact in all occurring operating conditions (when used as a rod seal toward the rod and toward the housing) and seal against the existing fluid pressure. The dynamic mechanical properties of the thermoplastic material, such as low damping behavior and a relatively high modulus of elasticity, are advantageously used in the seal ring according to the invention. Since metallic springs are no longer required, the assembly as well as the disassembly of the seal ring is significantly simplified. A further advantage results because a more compact, i.e. shorter, design of the seal ring in the axial direction is made possible. The contact surfaces of the seal ring toward the sliding partner are thereby reduced, and the friction due to the seal ring is reduced. If the seal ring is used in analysis pumps, the dead volume may additionally be reduced, as a result of which the analysis times in the analysis pumps can be greatly shortened.

Thanks to the special shaping of the seal ring in the region of the transition, the extrusion tendency of the seal ring is greatly reduced. Since the transition is not stepped or provided with chamfers but rather has a rounded shape, the overall leakage when using the seal ring in a sealing arrangement may be reduced by an advantageous contact pressure progression.

According to the invention, it has been recognized that the embodiment of the shape of the transition may take place according to various design principles. According to a first advantageous variant, the transition is formed using bionic structure optimization, in particular according to the DIN ISO 18459 standard, preferably by means of the method of tensile triangles described there.

In another advantageous variant, the transition is shaped in such a way that it follows the curve of an inverse cotangent function.

In a third advantageous embodiment variant, the transition is designed such that its shape corresponds to a tangential sequence of circle segments with decreasing radius. For example, the radius may be halved from one circle segment to the next tangentially following circle segment. All principles have in common that a rounded, soft, and continuous transition is achieved.

According to the invention, it has been recognized that the use of a thermoplastic material with high chemical resistance and low damping is regarded as being particularly advantageous.

In a particularly advantageous development of the seal ring according to the invention, the thermoplastic material may be a UHMPE (ultra-high molecular weight PE), a PEEK (polyether ether ketone) or a fluoropolymer, for example PTFE (polytetrafluoroethylene), PFA (perfluoroalkoxy polymer), ETFE (ethylene tetrafluoroethylene copolymer), THV (tetrafluoroethylene hexafluoropropylene vinylidene fluoride), or PVDF (polyvinylidene fluoride). The use of a polymer mixture, a compound, consisting of at least two of the aforementioned polymers has been recognized as a further advantage.

In a first embodiment variant of the seal ring according to the invention, a radially extending flange is arranged in the region of the radial leg of the seal ring.

In an advantageous development, a sealing bead may be arranged on the flange, meaning that a sealing bead is located on the end face of the flange that faces away from or toward the pressure. The sealing bead advantageously assumes a sealing function in the region of the flange, so that a penetration of metallic edges of the housing into the seal ring is no longer necessary and stresses may be reduced.

In an alternative advantageous embodiment variant of the seal ring according to the invention, the seal ring has no flange. Instead, on its side facing toward the pressure, the outer axial leg is provided with at least one axially projecting knob for fixing the seal ring in the axial direction.

In the installed state of the seal ring, in a sealing arrangement chamber, meaning under compression of the seal ring, the at least one knob, which may be arranged in the region of the static sealing edge, prevents an axial movement of the seal ring. When using the seal ring in a sealing arrangement in analysis pumps, the measurement reliability may thus also be increased, whereas faulty measurements may occasionally occur when seal rings with flanges are used in analysis pumps.

It has been recognized according to the invention that it is advantageous if the angle between the dynamic sealing edge and the axial direction of the seal ring, and/or the angle between the static sealing edge and the axial direction of the seal ring, is respectively 45° to 70°, in particular 50° to 70°, and preferably approximately 60°.

In a development of the seal ring according to the invention, the side of the seal ring that faces toward the pressure may be at least partially provided with a material that is highly chemically resistant, in the form of an inlay (meaning with an installed cover) or in the form of a coating which, for example, may be sprayed on. The material of the seal ring may thus advantageously be selected to the effect that particularly good elasticity and high extrusion resistance are achieved, whereas the chemical resistance may be improved by the inlay or coating.

The invention also relates to a sealing arrangement with a static housing and, as a machine element, a rod capable of a stroke motion relative thereto, or a piston or plunger capable of a stroke motion relative thereto, thus a piston rod; and to a seal ring as described above, arranged in a sealing gap between the housing and machine element.

The invention further relates to the use of a sealing arrangement as described above in high-pressure pumps, in particular in process pumps and analysis pumps, which may be used in particular for aggressive fluids.

The described invention and the described advantageous developments of the invention in combination with one another, insofar as this is technically sensible, also constitute advantageous developments of the invention.

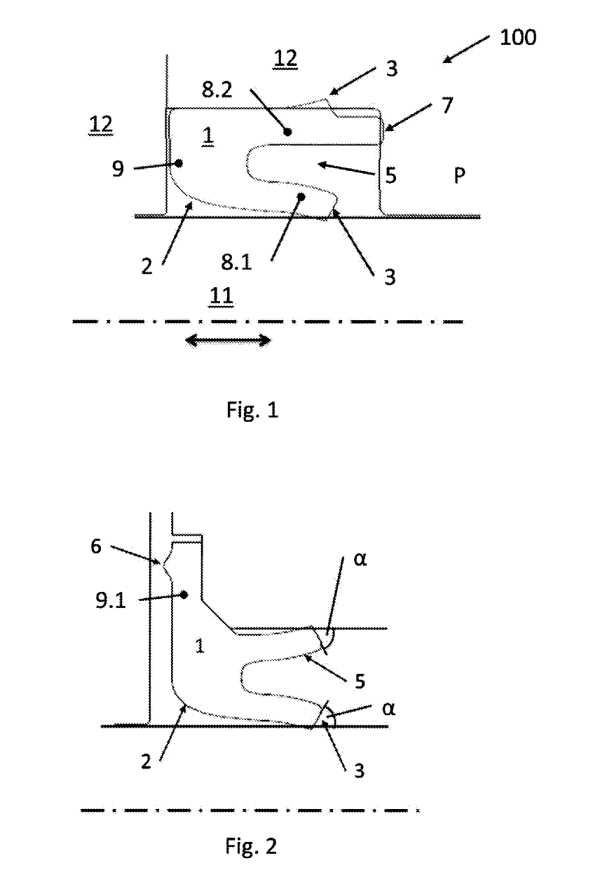

Depicted in FIG. 1 is a seal arrangement 100 according to the invention, with a seal ring 1 according to the invention. The seal ring 1 is arranged in a sealing gap between a stationary housing 12 and a machine element 11 capable of a stroke motion. The seal ring 1 has an axially extending radially inner axial leg 8.1 with a sealing lip 3, and a second axially extending radially outer axial leg 8.2 with a sealing lip 3. Located at the radially inner axial leg 8.1 is the sealing lip with the dynamic sealing edge 3; located at the radially outer axial leg 8.2 is the sealing lip with the static sealing edge 3. Both axial legs 8.1, 8.2 are connected to one another by a radially extending radial leg 9. A recess 5 is formed by the radial leg 9 and the axial legs 8.1, 8.2. The side of the recess 5 represents the side of the seal ring 1 facing the pressure, and a pressure P is present in the recess 5. The seal ring 1 is in this case manufactured from a thermoplastic material, for example from a fluoropolymer. The transition 2 of the outer surface of the radially inner axial leg 8.1 to the outer surface of the radial leg 9 is designed as a rounded, soft, and continuous transition. As a result, an extrusion of the material of the seal ring 1 into the gap between the moving machine element 11 and the stationary housing 12 is significantly reduced during a stroke movement of the machine element 11. The transition of the axial legs 8.1, 8.2 to one another in the region of the radial leg 9 is likewise designed to be soft and continuous, which leads to low notch stresses in this region.

The seal ring 1 from FIG. 1 has the additional feature of a knob 7 which is arranged projecting axially on the side of the outer axial leg 8.2 that faces toward the pressure. In the depiction of FIG. 1, the seal ring 1 is in a compressed state, and it can be seen that the knob 7 prevents axial movement of the seal ring 1.

FIG. 2 shows an alternative embodiment variant of the seal ring 1. The seal ring 1 has a flange 9.1 in the region of the radial leg 9. A sealing bead 6 is arranged on the end face of flange 9.1 that faces away from the pressure. In the depiction of FIG. 2, the seal ring 1 is already installed but has not yet been compressed. Given a corresponding compression of the seal ring 1 by movement of the housing part 12, the sealing bead 6 is deformed and then fulfills a sealing function.

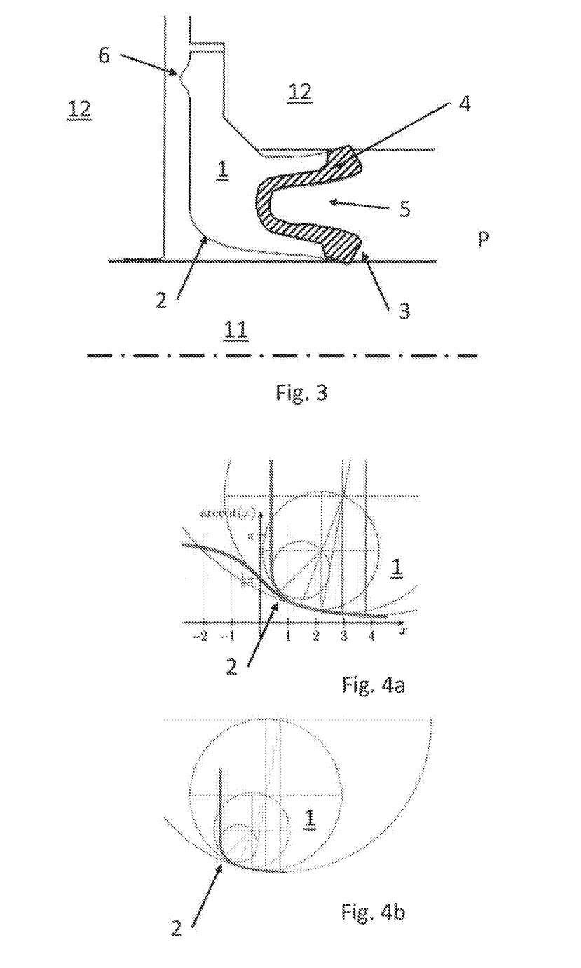

The sealing lip angle a is indicated in FIG. 2. The sealing lip angle a designates the angle between the dynamic sealing edge 3 and the axial direction, or the angle between the static sealing edge 3 and the axial direction. The axial direction of the seal ring is indicated by the dash-dotted line, which simultaneously forms the center line of the machine element 11. The sealing lip angle α has a value of approximately 60°. This also applies to the sealing lip angles a not drawn in FIGS. 1 and 3.

FIG. 3 shows a development of the seal ring 1. In its region facing toward the pressure, and in particular also in the region of the outer surface of the recess 5, the seal ring 1 has an inlay or coating 4 which is made of a material that is especially highly chemically resistant.

It is indicated in FIGS. 4a and 4b how the transition 2 of the seal ring 1 may be formed, and how a rounded shape of the transition may be determined structurally.

FIG. 4a shows that the transition 2 may follow the shape of an inverse cotangent. FIG. 4b shows an alternative possibility of designing the shape of the transition 2: In this instance, the radii of a plurality of reference circles are placed in a row one next to the other so that they transition tangentially into one another. This starts with a reference circle with a large radius, wherein the radii are reduced from one reference circle to the next reference circle. In the depicted example of FIG. 4b, the radii were reduced by a factor of approximately 2, meaning that the radii were approximately halved. A further alternative possibility for the design of the transition 2 of the seal ring 1 consists in the application of the method of tensile triangles. This method is presented in detail in Section 6.5 of the August 2016 edition of DIN ISO 18459. Its visualization is therefore omitted at this point.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMBERS

1 Seal ring

### 2 Transition

3 Sealing lip with sealing edge
4 Inlay or coating

### 5 Recess

6 Sealing bead

### 7 Knob

8.1 Radially inner axial leg
8.2 Radially outer axial leg

### 9 Radial leg

### 9.1 Flange

11 Machine element (rod/piston/plunger)

### 12 Housing

100 Sealing arrangement

### P Pressure

α Sealing lip angle

What is claimed is:

1. A seal ring in the form of a grooved ring for sealing a movable machine element toward a stationary housing, comprising:
a radially inner axial leg with a dynamic sealing edge;
a radially outer axial leg with a static sealing edge; and
a radial leg connecting the two axial legs,
wherein the seal ring is comprised of a thermoplastic material,
wherein a recess is formed between the two axial legs and the radial leg, and
wherein the radially inner axial leg has, on a surface of the radially inner axial leg on a machine element side, a rounded transition to a surface of the radial leg that faces away from a pressure.

2. The seal ring according to claim 1, wherein the transition is formed using bionic structure optimization, or the transition follows a curve of an inverse cotangent function, or the transition has a form of a tangential sequence of circle segments with decreasing radii.

3. The seal ring according to claim 1, wherein the thermoplastic material has a high chemical resistance and low damping.

4. The seal ring according to claim 1, wherein the thermoplastic material comprises UHMPE, PEEK, PK, THV, or a fluoropolymer, or a polymer mixture of at least two of the aforementioned polymers.

5. The seal ring according to claim 1, further comprising a radially extending flange arranged at the seal ring in a region of the radial leg.

6. The seal ring according to claim 5, further comprising a sealing bead arranged on the radially extending flange.

7. The seal ring according to claim 1, wherein the outer axial leg is provided, at a side of the outer axial leg facing toward the pressure, with at least one axially projecting knob configured to fix the seal ring in an axial direction.

8. The seal ring according to claim 1, wherein an angle between the dynamic sealing edge and the axial direction, and/or an angle between the static sealing edge and an axial direction, is respectively 45° to 70°.

9. The seal ring according to claim 1, wherein a side of the seal ring facing toward the pressure is provided with a highly chemically resistant material comprising an inlay or a coating.

10. A sealing arrangement, comprising:
a static housing;
as a machine element, a rod configured to provide a stroke motion relative thereto, or a piston or plunger configured to provide a stroke motion relative thereto; and
the seal ring according to claim 1.

11. A method of using the sealing arrangement according to claim 10, comprising:
using the sealing arrangement in a high-pressure pump.
